(19) United States
(12) Patent Application Publication
(10) Pub. No.: US 2008/0194368 A1
(43) Pub. Date: Aug. 14, 2008

(54) Apparatus for Actuating a Motor Vehicle Transmission

(75) Inventors: Norbert Ebner, Ludwigsburg (DE); Thomas Listner, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimierChrysler AG, Stuttgart (DE)

(21) Appl. No.: 11/579,811

(22) PCT Filed: Apr. 27, 2005
(86) PCT No.: PCT/EP2005/004486

§ 371 Date: Nov. 7, 2007

(30) Foreign Application Priority Data
May 7, 2004 (DE) 10 2004 022 616.4

(51) Int. Cl. F16H 3/72

(52) U.S. Cl. 475/5

(57) ABSTRACT

In a device with a unit for actuating a motor vehicle transmission superimposes a first torque of a first drive assembly with at least one second torque of a second drive assembly, the unit modifies the first torque and the second torque in order to fulfill a propulsion request of an operator. According to the invention, the unit also regulates the rotational speed of the second drive assembly during a modification of the first torque.

### BACKGROUND AND SUMMARY OF THE INVENTION

This application claims the priority of German patent document 10 2004 022 616.4, filed May 7, 2004 (PCT International Application No. PCT/EP2005/004486, filed Apr. 27, 2005) the disclosure of which is expressly incorporated by reference herein.

The invention relates to a device comprising a unit for actuating a motor vehicle transmission.

Such a device of the generic type is disclosed in German patent document DE 196 06 771 C2. The motor vehicle transmission in this case is provided for use in a motor vehicle with hybrid drive and has first and second input shafts. The first input shaft is for transmission of a first torque generated by a drive assembly designed as an internal combustion engine, and the second, which is in the form of a hollow shaft, is for transmission of a second torque that can be generated by a drive assembly having an electric motor. The first input shaft is connected to a third drive assembly in the form of an electric motor that (like the second drive assembly) can also be used as a generator unit. The unit is provided to modify the torques of the drive assemblies in order to fulfill a propulsion request of an operator.

One object of the invention is to provide a particularly simple and reliable method and appartus for actuation of a motor vehicle transmission that superimposes torques of at least two drive assemblies.

This and other objects and advantages are achieved by the invention, which includes a device having a unit for actuating a motor vehicle transmission that superimposes a first torque of a first drive assembly with at least one second torque of a second drive assembly. The unit modifies the first torque and the second torque in order to fulfill a propulsion request of an operator.

According to the invention, the unit is provided to regulate a rotational speed of the second drive assembly during a modification of the first torque, which can enable the second torque of the second drive assembly to adapt itself automatically to a modified first torque. The need for explicit control of the second drive assembly can therefore be eliminated, so that the motor vehicle transmission can be particularly easily and reliably actuated.

“Provided” should be understood in this context also as “designed” and “equipped”. Embodiments of the invention are also possible in which a closed-loop control circuit of the unit for regulating the rotational speed is integrated into the second drive assembly or is given by a separate sub-unit of the unit. Modification of the first torque can also be integrated into a closed-loop control circuit. The propulsion request can be encoded as a nominal acceleration, a nominal output, a nominal torque, a nominal speed or as any other parameter that appears expedient to a person skilled in the art. The drive assemblies can be of the same type or different, although the solution the invention allows advantages to be obtained in particular when the respective drive assemblies exhibit different reaction behavior to control signals.

The different reaction behavior (and hence the different reaction times) of the drive assemblies have no negative influence on the behavior of the motor vehicle transmission if, after a start of a modification of the torque of the first drive assembly, the rotational speed of the second drive assembly is held constant at least for a short period of time (for example, 100 ms). This can also ensure that no undesired change in the transmission ratio of the motor vehicle transmission occurs during a change in the torque of the first drive assembly.

A torque equilibrium in the motor vehicle transmission that is balanced at all times can be achieved if a reaction time of the second drive assembly is shorter than a reaction time of the first drive assembly.

If the unit is provided to actuate at least one drive assembly that can be used as a generator unit, the unit can advantageously control or regulate energy generation, depending on the demand. The first or the second drive assembly or a further drive assembly can be used here as generator unit. If the unit is provided to connect the first drive assembly to the drive assembly that can be used as a generator unit, the first drive assembly can advantageously be used to generate electrical energy. Such a connection is particularly expedient if the first drive assembly is powered by a non-electrical energy accumulator. It is also possible that the drive assembly that can be used as a generator unit uses braking energy to generate electric current.

A separate charger unit can be avoided if the unit controls charging of an energy accumulator.

A particularly comfortably operated motor vehicle can be achieved if the unit is designed to determine the propulsion request as a function of a drive pedal position.

Selective actuation of a motor vehicle transmission can be achieved if the unit sets a nominal transmission ratio of the motor vehicle transmission, as determined by the unit itself or by a separate unit. A transmission ratio on motor vehicle transmissions that are provided for the superimposition of several torques often depends on a torque equilibrium between the torques. The unit can then advantageously set a transmission ratio of the motor vehicle transmission (i.e., a ratio of rotational speed of a given input shaft to rotational speed of an output shaft) by modifying a torque or several torques.

A particularly significant simplification of the closed-loop control of the motor vehicle transmission or drive assemblies can be achieved if the first drive assembly is an internal combustion engine, as such drive assemblies can have a particularly complex reaction behavior to control signals.

If the unit is provided to trigger a shift process as a function of a demanded output, all propulsion requests within the output limits of the drive assemblies can be implemented.

The invention is provides a method for actuating a motor vehicle transmission which superimposes a first torque of a first drive assembly with a second torque of a second drive assembly, in which the first torque and/or the second torque are modified in order to fulfill a propulsion request of an operator.

According to the invention, rotational speed of the second drive assembly is regulated at least during a modification of the first torque.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a device comprising a unit according to the invention for actuating a motor vehicle transmission and three drive assemblies;

FIG. 2 is a functional block diagram of the unit from FIG. 1; and

FIG. 3 is a flow diagram that illustrates open-loop control function of the unit.

### DETAILED DESCRIPTION OF THE DRAWINGS

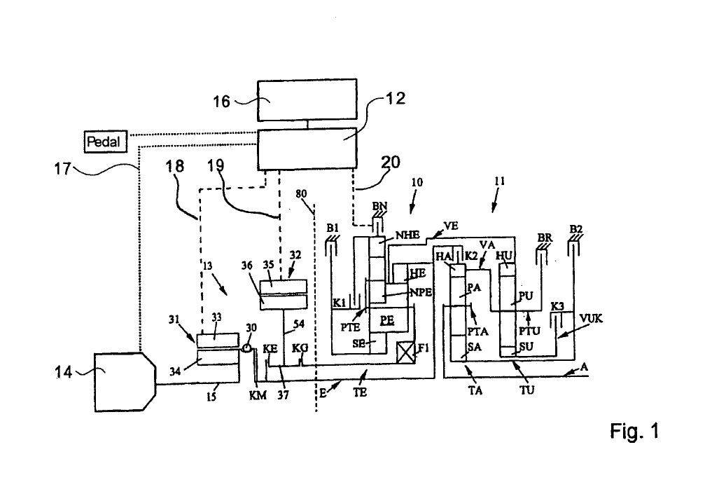

FIG. 1 shows a device comprising a unit 12 for actuating a motor vehicle transmission, the motor vehicle transmission 10, a first drive assembly 14 in the form of an internal combustion engine, a second drive assembly 32 that comprises an electric motor and can be used as a generator unit, and a further drive assembly 31 that is designed as an electric motor and can be used as a generator unit. The second drive assembly 32 is referred to in the further description of FIG. 1 as second electric drive assembly and the further drive assembly 31 as first electric drive assembly.

The unit 12 has connections for control leads 17, 18, 19 by means of which it can modify torques generated by the drive assemblies 14, 31, 32 independently of one another in order to fulfill a propulsion request of an operator. The control leads 17, 18, 19 are part of a CAN-Bus system via which the unit 12 has access to all information acquired in a motor vehicle in which the device is contained, in particular to a speed and to an acceleration of the motor vehicle that can be calculated from the speed or that can be acquired independently of the acceleration. The unit 12 is linked to actuators (not illustrated) of the motor vehicle transmission 10 by means of which the clutches and brakes of the motor vehicle transmission 10 can be engaged and disengaged. Only one signal line 20 between unit 12 and brake BN is illustrated as an example.

The motor vehicle transmission 10 has a part-transmission 11 designed as an automatic transmission, and a hybrid set 13 installed upline of the part-transmission 11. Power is transmitted between part-transmission 11 and the hybrid set 13 by means of an input shaft E.

An input-side planetary gear part-transmission TE of the part-transmission 11 has a planetary gear carrier PTE in which planetary gears PE are pivotably mounted. An outer central gear wheel HE with a rotationally fixed connection to the input shaft E meshes with the planetary gears PE. Furthermore, an inner central gear wheel SE connected to an engageable and disengageable friction brake B1 and to an engageable and disengageable clutch K1 also meshes with the planetary gears PE. Arranged between the planetary gear carrier PTE and a non-rotating housing section GT is a freewheel coupling F1 that engages if the planetary gear carrier PTE rotates in a direction opposite to that of the input shaft E. (According to an alternative embodiment of the part-transmission 11, implementation of the freewheel clutch can be omitted.) An output-side planetary gear part-transmission TA has a planetary gear carrier PTA in which planetary gears PA are pivotably mounted, said planetary gear carrier PTA having a rotationally fixed drive connection to an output shaft A. An outer central gear wheel HA that is connected to the input shaft E by means of an engageable and disengageable friction clutch K2 meshes with the planetary gears PA. Furthermore, an inner central gear wheel SA connected to an engageable and disengageable brake B2 meshes with the planetary gears PA.

A planetary gear reversing part-transmission TU has a planetary gear carrier PTU in which planetary gears PU are pivotably mounted, said planetary gear carrier PTU being connected to an engageable and disengageable friction brake BR and having a rotationally fixed drive connection VA to the outer central gear wheel HA of the output-side part-transmission TA. An outer central gear wheel HU with a drive connection VE to the planetary gear carrier PTE of the input-side part-transmission TE meshes with the planetary gears PU. Furthermore, an inner central gear wheel SU meshes with the planetary gears PU.

Provided between the two inner central gear wheels SA and SU is a drive connection VUK that can be separated by means of an engageable and disengageable friction clutch K3.

Also pivotably mounted on the planetary gear carrier PTE are secondary planetary gears NPE that mesh with both the planetary gears PE and an outer secondary central gear wheel NHE that is connected to an engageable and disengageable friction brake BN.

The power flow of an engine shaft 15 from the first drive assembly 14 to the hybrid set 13 is transmitted via a torsion damper 30 and a clutch module KM installed in series and downline from the torsion damper to the input shaft E. For an alternative form of the illustrative embodiments described, the torsion damper 30 is installed downline of the clutch module KM, in particular of a wet starting clutch.

As noted previously, motor vehicle transmission 10 has a first electric drive assembly 31 and a second electric drive assembly 32. The first electric drive assembly 31 has a stator 33 fixed to the housing that interacts with the rotor 34 to generate a drive torque and/or to recoup electrical energy. The rotor 34 has a fixed drive connection to the input side of the torsion damper 30 or the motor shaft 15, so that by means of the first electric drive assembly 31, torque can be fed into the powertrain 10 or torque prevailing in the powertrain 10 can be utilized (at least partially) to regenerate electrical energy in addition to the internal combustion engine.

The second electric drive assembly 32 has a stator 35 and a rotor 36. The stator 35 is fixed to the housing, while the rotor 36 has a drive connection by means of an intermediate shaft 37 that has two clutches KE, KG. The intermediate shaft 37 can be directly connected to the input shaft E by means of the clutch KE.

The intermediate shaft 37 can be connected directly to the sun wheel SE of the part-transmission TE by means of the clutch KG.

The electric drive assemblies 31, 32 are fed by at least one energy accumulator 16.

The motor vehicle transmission 10 permits a continuously variable transmission ratio with two drive ranges. In particular, the continuously variable transmission ratio is obtained by a superimposition of the drives
by means of the second electric drive assembly 32, and
by means of the drive assembly or the internal combustion engine that has a drive connection to the engine shaft 15, and/or by the first electric drive assembly 31
   via the planetary gear part-transmission TE. The torque is transmitted to the part-transmission TA in a first drive range via the output element VE and in a second drive range via the output element VE, and the clutch K2 and the central gear wheel HA.

In a first drive range, the shift elements KG, B2, K3 are closed. In this drive range, power is transmitted from the output element VE via the planetary gear reversing part-transmission TU, when driving the outer central gear wheel HU and the inner central gear wheel SU fixed to the housing, to the planetary gear carrier PTU. The latter has a drive connection to the output shaft A via the drive connection VA and the planetary gear part-transmission TA, with the drive connection VA being connected to the outer central gear wheel HA, the inner central gear wheel SA being fixed to the housing and the output shaft having a rotationally fixed connection to the planetary gear carrier PTA.

The first drive range is preferably assigned to speeds from −x through zero to +x, whereby the reverse speed can be limited by means of the control device. Speeds from (−75 km/h) −30 km/h to +75 km/h are preferably assigned to the first drive range. Depending on the design and interaction of the electric drive assembly and the drive assembly, the maximum output torque can be limited by one of the two above-mentioned assemblies and is, for example, 1300 Nm, particularly in the range between 10 km/h and 40 km/h. The limit values of the transmission ratio lie—depending particularly on the engine rotational speed—between −0.65 and +0.58, although the limit values in the part-load range may be reduced.

In a second drive range, the shift elements KG, K2, K3 are closed. In this drive range, power is transmitted from the output element VE via the planetary gear reversing part-transmission TU, when driving the outer central gear wheel HU. The inner central gear wheel SU has a rotationally fixed connection via the clutch K3 to the inner central gear wheel SA of the planetary gear part-transmission TA. The planetary gear carrier PTU is connected via the drive connection VA to the outer central gear wheel HA, which also has a rotationally fixed connection to the input shaft E via the clutch K2. The planetary gear carrier PTA has a rotationally fixed connection to the output shaft A.

The second drive range is preferably assigned to higher travel speeds (for example, from roughly 40 km/h to +300 km/h). The maximum output torque is lower than in the first drive range (for example 440 Nm in the range between 50 km/h and 250 km/h). The limit values of the transmission ratio lie between for example −1.7 and +0.34, as a function of the engine rotational speed, while smaller transmission ratios are possible than in stage operation, as a function of the rotational speeds of the drive assemblies.

In the second drive range there is in particular a reduced torque load on the electric drive assemblies 31, 32. The overall transmission ratio of the transmission is extended to overdrive ranges of 0.4 and below.

A changeover between the two drive ranges takes place when the rotational speed of the input shaft E and the second electric drive assembly 32 have the same rotational speeds in both drive ranges. This corresponds in particular to the transmission ratio of the gear represented by the open shift elements B1, BN and K1. For this type of change from one drive range to the other drive range, no acceleration or deceleration of the inertia masses is necessary, while at least the torque of the second electric drive assembly 32 is modified in absolute terms and changes its direction.

The configuration and function of the motor vehicle transmission 10 is described in detail in the PCT application with the international reference number PCT/EP 03/11980, the content of which is hereby incorporated by reference. The motor vehicle transmission can, of course, also have any other structural form appearing to the person skilled in the art as being expedient.

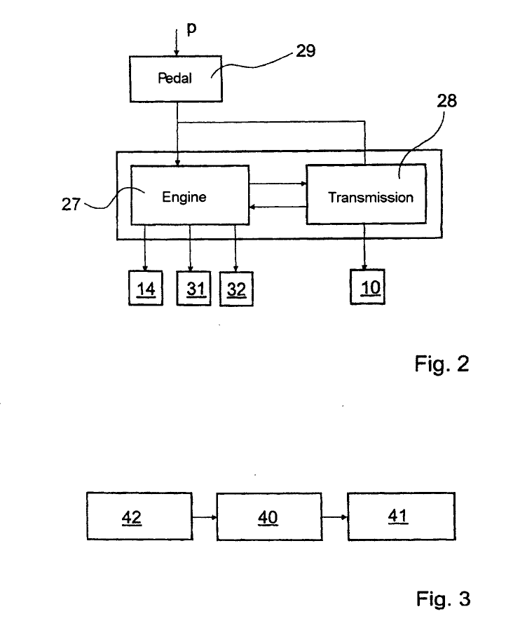

FIG. 2 is a functional diagram of the unit 12 from FIG. 1. The unit 12 comprises an engine control block 27 to control the drive assemblies 14, 31, 32 and a transmission control block 28 to control the clutches and brakes of the motor vehicle transmission 10. Both the engine control block 27 and transmission control block 28 receive a nominal propulsion signal from a device 29 for determination of a propulsion request, based on a drive pedal position p as a function of a travel speed of the motor vehicle, and encodes a propulsion request of the operator or driver. The engine control block 27 and the transmission control block 28 exchange information on a current state of the drive assemblies 14, 31, 32 and of the motor vehicle transmission 10.

In the illustrative embodiment shown, the nominal propulsion signal has a value range from −100% to 100% and indicates a percentage output and/or acceleration vector in relation to a momentary speed. Depending on the nominal propulsion signal, the engine control block 27 determines the torques of the drive assemblies 14, 31, 32 in such a way that a total torque is determined by the nominal propulsion signal and that one of electric the drive assemblies 31, 32 assumes a generator function due to a negative torque and at least essentially assumes a power supply to the respective other drive assembly 31, 32.

It is furthermore possible for a limited time for both machines 31, 32 to operate in motive or generative mode. This only applies, however, if the necessary torque ratios can nevertheless still be assured. In this case, for example, the second drive assembly 32 assumes the generator function below a limit speed of the motor vehicle determined by a rotational speed of the first drive assembly 14, and the further drive assembly 31 assumes the generator function above this limit speed. The limit speed depends here on the nominal propulsion signal.

FIG. 3 shows a sequence of a cyclically performed function of the engine control block 27 that is implemented in the case of a non-zero nominal propulsion signal. In a first step 42, the unit 11 modifies the torque of the first drive assembly 14 (an internal combustion engine) and hence the torque prevailing at the engine shaft 15 by a proportion of a value determined by the nominal propulsion signal. In a second step 40, the unit 12 checks whether the rotational speed ω₂ of the second drive assembly 32 acquired via the control lead 19 corresponds to a stored setpoint whose default value is a rotational speed acquired in a preceding time interval. If not, the unit 12 increases or decreases the torque of the second drive assembly 32 as a function of the deviation between the rotational speed ω₂ and the setpoint. Step 40 is repeated until the deviation between the rotational speed ω₂ and the setpoint is within a preset tolerance. The unit 12 thus regulates the rotational speed ω₂, while it modifies the first torque of the first drive assembly 14. Other embodiments of the invention with more complex control loops for the rotational speed ω₂ are conceivable.

On completion of an acceleration process, the total torque of the drive assemblies 14, 32 and the torque of the drive assembly 31 should at least essentially have changed in the same ratio. This is checked in a step 41 in which the unit 12 acquires a rotational speed of the engine shaft 15 via the signal lead 17 and calculates a rotational speed of the output shaft A from the vehicle speed acquired via the CAN-bus system. It also calculates the transmission ratio between the engine shaft 15 and the output shaft A by forming the ratio of the two rotational speeds, and comprises the result with a stored nominal transmission ratio. If the calculated transmission ratio differs from the stored nominal transmission ratio, the unit 12 modifies the torques of the drive assemblies 14, 31, 32 in step 41 until a match is obtained.

The transmission ratio calculated in step 41 is determined by an actual torque of the first drive assembly 14 which follows a torque controlled in step 42, with a delay determined by the reaction time of the first drive assembly 14. The reaction time of the second drive assembly 32 is significantly shorter than the reaction time of the first drive assembly 14, so that the transmission ratio during a modification process of the torque of the output shaft A remains essentially unchanged, and hence the torque of the second drive assembly 32 can always closely follow the torque of the first drive assembly 14 in the manner described above.

In step 41 the unit 12 furthermore checks whether the demanded torques of the drive assemblies 14, 31, 32 exceed preset, rotational speed-dependent threshold values. If so, the unit 12 generates a shift signal that triggers a shift process in the transmission control block 28, during which the unit 12 actuates the clutches and/or brakes of the motor vehicle transmission 10 as a function of how the limit values have been overshot.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A device comprising a unit for actuating a motor vehicle transmission that superimposes a first torque of a first drive assembly on at least one second torque of a second drive assembly; wherein
said unit modifies the first torque and the second torque to fulfill a propulsion request of an operator; and
said unit regulates a rotational speed of the second drive assembly during modification of the first torque.

2. The device as claimed in claim 1, wherein the unit holds the rotational speed of the second drive assembly constant after start of a modification of the first torque.

3. The device as claimed in claim 1, wherein reaction time of the second drive assembly is shorter than reaction time of the first drive assembly.

4. The device as claimed in claim 1, wherein the unit actuates at least one drive assembly that is operable as a generator unit.

5. The device as claimed in claim 4, wherein the unit connects the first drive assembly with the drive assembly that is operable as a generator unit.

6. The device at least as claimed in claim 4, wherein the unit controls a charging process of an energy accumulator.

7. The device as claimed in claim 1, wherein the unit determines the propulsion request based on a drive pedal position (p).

8. The device as claimed in claim 1, wherein the unit sets a nominal transmission ratio of the motor vehicle transmission.

9. The device as claimed in claim 1, wherein the first drive assembly comprises an internal combustion engine.

10. The device as claimed in claim 1, wherein the unit triggers a shift process as a function of a demanded output.

11. A method for actuating a motor vehicle transmission that superimposes a first torque of a first drive assembly on a second torque of a second drive assembly said method comprising:
modifying at least one of the first torque and the second torque to fulfill a propulsion request of an operator; and
regulating rotational speed of the second drive assembly at least during a modification of the first torque.
